(19) United States
(12) Patent Application Publication
(10) Pub. No.: US 2014/0147600 A1
(43) Pub. Date: May 29, 2014

(54) Method and Apparatus for Lining Pipe and Similar Structures

(71) Applicants: John Dennis Neukirchen, Kirkland, WA (US); Mladen Bumbulovic, Vancouver (CA)

(72) Inventors: John Dennis Neukirchen, Kirkland, WA (US); Mladen Bumbulovic, Vancouver (CA)

(21) Appl. No.: 14/090,885

(22) Filed: Nov. 26, 2013

Related U.S. Application Data
(60) Provisional application No. 61/729,896, filed on Nov. 26, 2012.
(60) Provisional application No. 61/828,102, filed on May 28, 2013.

(51) Int. Cl. B05D 7/14

(52) U.S. Cl. CPC B05D 7/146
USPC 427/535; 148/519; 427/239

(57) ABSTRACT

An apparatus and method of coating and/or lining of the interior of pipes and tubular goods with a performance enhancing layer of metal alloy using a 360° radiant heat source. The use of the disclosed apparatus and methods facilitates the capability to metallurgically bond a layer of metal alloy or composite material to the interior of a steel pipe or similar metal based tubular good with a primary diameter ranging typically from 1.5″ to 8″. The disclosed apparatus and methods are especially useful to produce piping used in the conveyance and/or transportation of hot, corrosive and/or abrasive fluids in the oil and gas, and mining Industries.

### CROSS-REFERENCE TO RELATED APPLICATION

This application claims the benefit of U.S. Provisional Patent Application No. 61/729,896 filed Nov. 26, 2012, the contents of which are hereby incorporated by reference. This application also claims priority to U.S. Provisional Patent Application No. 61/828,102, filed May 28, 2013, the contents of which are hereby incorporated by reference.

### TECHNICAL FIELD

This description relates generally to piping and more specifically to the lining of pipes and cavities.

### BACKGROUND

Metal pipe such as ductile iron pipe or the like may be used to transport liquids and other materials. Typically, pipe may be manufactured using centrifugal casting in metal or resin lined molds. Pipe may be provided with protective internal linings and external coatings to inhibit corrosion or extend wear. Iron pipes may have internal lining of cement mortar and may have external coatings which may include metal, asphalt, paint or the like. Life expectancy of pipes depends on factors including corrosiveness of the environment, and the abrasiveness of the material flowing in the pipes.

A lining may be desirable so that a cost effective pipe material that may be subject to corrosion or wear may form a supporting structure. Then a tougher, but more expensive material or coating, may be applied to protect the base material from corrosion and or wear.

Conventional linings may be applied in various ways including painting, galvanic plating, hot dipping, and the like. Processes like plating can have adverse environmental impact as plating solution disposal can be problematic. Accordingly it would be desirable to be able to apply a metal interior coating to a pipe or equivalent hollow structure that is environmentally friendly, efficient, economical, and durable.

A common problem experienced throughout industry and in particular the oil and gas industry has been the protection of valuable processing equipment, containment vessels, and piping systems from exposure to harsh and corrosive service conditions and the production of suitably sized lined pipe.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides systems and methods for metallurgical bonding of a layer of metal alloy or composite material to form a lining to the interior surfaces of steel pipe or similar metal based pipes and tubular goods ranging typically from 0.5″ to 8″ in diameter by the use of a substantially 360° energy radiation emitting heat source. Such a layer of material can be described equivalently as a corrosion resistant alloy, chemical resistant alloy, or CRA. The disclosed apparatus and methods for producing such lined pipe may be especially useful in the conveyance and/or transportation of hot, corrosive and/or abrasive fluids in the Oil and Gas and Mining Industries.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a conventional pipe showing wear due to internal abrasion from a material flowing through the pipe, or other wear mechanisms.

FIG. 2 shows a piping system including lined pipe produced by the system and method for lining pipe described herein.

FIG. 3 is an overall process flow diagram for producing lined pipe as described herein.

FIG. 4 is a sub-process flow diagram of the Pipe Preparation: Washing and Drying process.

FIG. 5 is a sub-process flow diagram of Pipe Preparation: Corrosion Removal and Dust Removal process.

FIG. 6 is a sub-process flow diagram of the CRA Material Preparation process and the CRA Material Application process.

FIG. 7 is a sub-process flow diagram of the Drying CRA Material process.

FIG. 8 is a sub-process flow diagram of the Fusion Bonding of CRA Material process and the Solidification of Fused CRA Material process.

FIG. 9 is a sub-process flow diagram of the Hydrotesting and the Non-Destructive Evaluation (NDE) processes.

FIG. 10 is a block diagram showing various control software modules utilized to implement the processes described herein.

FIG. 11 illustrates an exemplary computing environment in which the process for producing lined pipe described in this application, may be implemented.

FIG. 12 shows an apparatus for mixing and delivering uncured lining material.

FIG. 13 shows an apparatus for applying the uncured lining material to the interior surface of a pipe or other elongate interior surface.

FIG. 14 shows an apparatus for rotating a pipe while the lining material is being cured.

FIG. 15 shows the apparatus for rotating a pipe during the disposition of an uncured lining and during the curing process.

FIG. 16 shows an end view of the apparatus for rotating a pipe.

FIG. 17 shows details of a lamp assembly for curing the lining material.

FIG. 18 shows a system for controlling the lamp assembly and pipe rotation.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a system and method for lining pipes. Although the present examples are described and illustrated herein as being implemented in a piping system, the system described is provided as an example and not a limitation. As those skilled in the art will appreciate, the present examples are suitable for application in a variety of different types of systems such as pipes, tubular goods and other elongate, hollow members.

As used herein a “stinger” will refer to a rod or elongate member used to hold a device at its end. The stinger allows the device to be inserted into a tubular cavity-such as the interior of a pipe or the like, and to be withdrawn.

The invention relates to the metallurgical bonding of a layer of metal alloy or composite material in form of a lining or cladding to the interior surfaces of pipes and tubular goods ranging primarily from 0.5″ to 8″ in diameter by means of a 360° energy radiation emitting heat source. This is typically a much smaller diameter than may be lined by conventional methods using heat lamps.

In the exemplary oil and gas industries the internal surfaces of pipe and piping systems used are constantly exposed to the aggressive solutions. High strength carbon steel pipe is often used and by nature it is not resistant to attack from aggressive solutions and is typically lined with a corrosion resistant liner capable of withstanding the aggressive environment through the designed life of the pipe or piping system.

Polymer based lining materials such as epoxies, vinyl esters, and phenolics or chemical compounded membrane such as EDPM, SBR, and NPR rubbers or HDPE, PVDF, and Halar type or similar plastic materials were used for many lining applications. These materials were low in cost, were reasonable to apply, and give acceptable service life for those conditions and exposures that are within the resistance capability. However, in current oil and gas industry installations these previously used coatings have been unsatisfactory, as materials having better long term resistance were called for.

As a result, the oil and gas industry has often used corrosion resistant steel such as Inconel 625, Inconel 825, and 316L stainless steel for those pipe or piping systems that were exposed to the new service conditions and that could not be replaced or serviced/relined on a determined or regular basis. This included most gathering lines, wells, risers, and a number of other important upstream or prior to refining applications including many pipelines. However this type of pipe typically costs 4 to 5 times more than the previously used polymer or compounded membrane lined carbon steel pipe,

A lower cost alternative is the use of cladding or overlaying high strength carbon steel pipe with a layer of CRA (chemical resistant alloy) on the interior surface to resist the aggressive service conditions. The thickness of the clad metal layer and the thickness and strength of the carbon steel pipe are determined by the service environment and the design life. The result is a significant cost savings with only a minor decrease in comparative performance to previously used pipe.

There are several methods of cladding or lining high strength steel pipe with CRA materials. One method is Weld Cladding—Weld Cladding is a welding process that builds a welded layer of corrosion and/or abrasion resistant metal onto a surface rather than joining two surfaces together. Beads or thin tracks of overlay metal are created by injecting a powder stream or wire into a weld arc, creating a melt pool of overlay metal. As the weld machine moves back and forth across the surface, the weld metal overlay surface is created. Weld cladding is commonly specified for use in seamless pipe.

Due to the size of the welding equipment and support apparatus, weld cladding of pipe is productively limited to 8″ ID pipe, but commonly accepted for 12″ OD pipe or greater. (for cost and production considerations) Due to intermixing/contamination of the base into the CRA during the weld clad process, the normal specified thickness of the clad layer is 3 millimeters. However, the useable thickness of CRA for long term resistance is around 1 to 1.25 mm.

A second, more economical process is Roll Bonding—Roll Bonding is a method of producing clad plates or sheets by hot press rolling a composite of steel plate and a plate of corrosion resistant material together, such as Inconel 625, Inconel 825, or 316L stainless steel. The clad plate is produced by placing the two sheets of material into an oven, where at a near molten state the two plates are roll pressed together where a solid phase weld is achieved. The typical use of clad plate is in the manufacture of pressure vessels and tanks. When used for the manufacture of pipe, the roll bonded plate is press rolled to the designed diameter and seam length welded.

In the manufacture of roll bonded pipe, there are several recognized supply issues. Roll bonded pipe is typically limited to large diameter applications due to the differential stresses created between the two dissimilar metal materials during the formation of smaller diameter clad pipe. Further, a weld seam consisting of two matching material types runs the entire length of the pipe which in some cases can weaken the pipe over time.

There are several other processes such as mechanical bonding a CRA liner using mandrel expansion and bimetal extrusion.

Accordingly, common limitation in the capability to effectively, and/or productively clad or line smaller diameter pipe. Small diameter pipe being categorized as 8″ diameter and smaller with the majority used between 6″ diameter to 2.5″ diameter is present. The examples described herein may allow the economical and efficient lining of a wide variety of pipes, not previously economically produced.

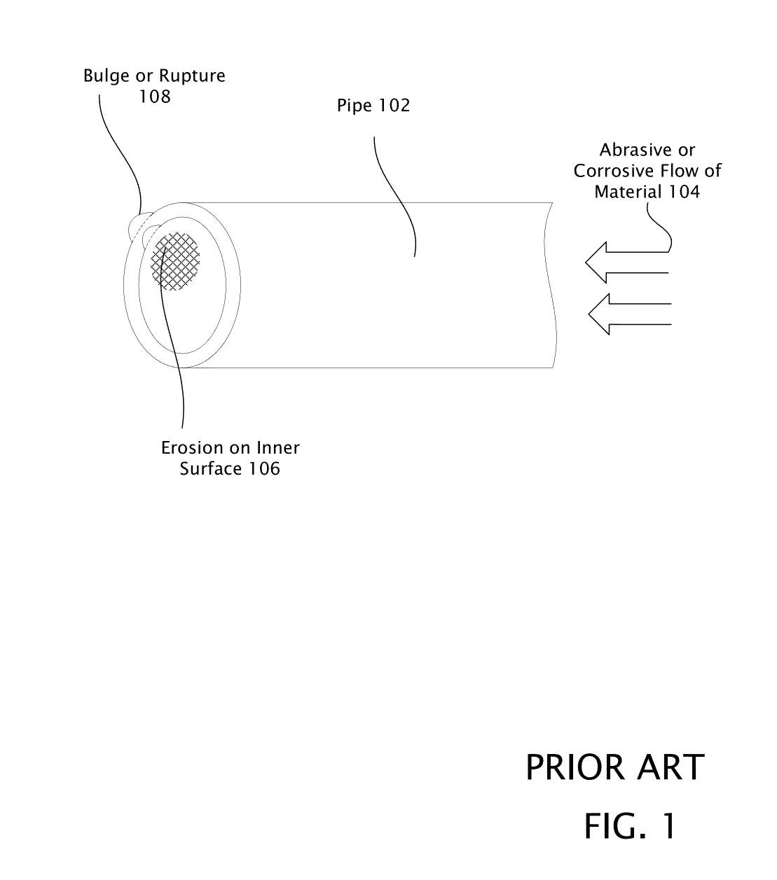

FIG. 1 shows a conventional pipe showing wear due to internal abrasion and wear from a material flowing through the pipe. A typical pipe material may be iron, steel, copper, or the like. These materials tend to be economical, and easily worked with. However, such a conventional pipe 102 can be exposed to materials 104 flowing through it or contained within it, which can be abrasive, corrosive, reactive or the like. Over time, the material 104 may cause erosion or weakening on the inner surface 106 of the pipe 102. The erosion 106 may cause weakness in the wall of the pipe that can result in a failure of the pipe such as a bulge, rupture or hole 108 in the wall of the pipe from a hole being eaten in the pipe, or alternatively from pressure in the pipe 102.

Less reactive, or more durable pipe 102 materials could be used. However, alternative materials may be expensive, or not have the desired properties needed for the mechanical instillation of the pipe 102. In an effort to provide piping that substantially has the mechanical and economic benefits of pipe 102, but is resistant to wear corrosion and the like, durable, noncorrosive, or the like pipe linings may be employed.

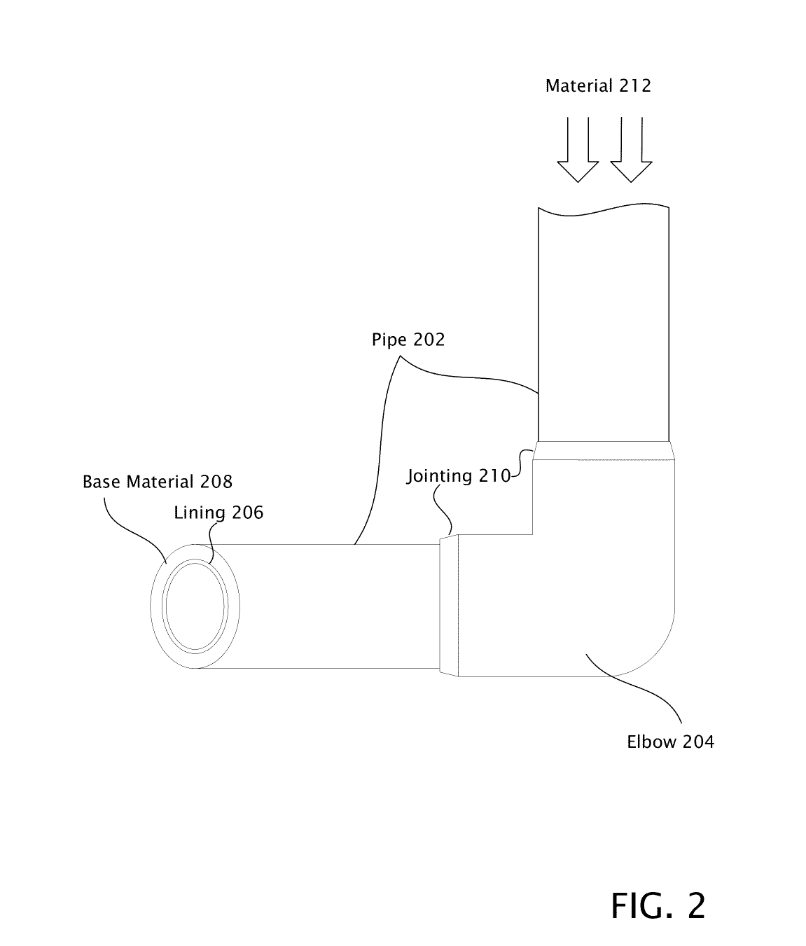

FIG. 2 shows a piping system including lined pipe produced by the system and method for lining pipe described herein. A plurality of pipes 202 may be joined into an exemplary piping system typically using a plurality of fittings such as flanges, couplers, or the like. Exemplary elbow 204 may be joined 210 to the pipe by welding, soldering, MIG welding, TIG welding, laser welding, friction welding, brazing, or may be achieved by mechanical means such as threaded couplings and the like.

The pipe 202 and various exemplary fittings 204 typically include a relative inexpensive and durable base material 208 and a non-reactive, or more durable lining 206 such as that produced by the system and method for lining pipes described herein. The lining 206 protects the pipe's base material 208 from abrasion, corrosion, or other adverse effects that may be induced by the flow of material 212 through the piping system. Even though the use of lining generally reduces the cost of lined pipe it may still be desirable to produce such pipe and components of a piping system in an economical way that preferably improves the quality of the lined pipe.

The pipes may be lined by applying a semi fluid material or paste to the interior of the pipe and fusing it to the pipe. As provided herein the use of such a metallurgical bonded metal alloy or composite to the inside surface of hollow members such as a pipe lining may enhance the performance of the pipe or member by reducing thickness of the lining, and loss to the goods due to environmental exposure. Such thickness loss, or wear and the like as previously stated, can cause pipe failure due to leaks, ruptures, or the like. Accordingly the metallurgical bonded metal alloy or composite as applied as described herein will tend to be tolerant of damage from handling as results from transportation and installation.

The metallurgical bonding of metal alloy or composites as described herein allows individual sections or lengths of the goods to be joined such that the resulting section improves the ability of the pipes or hollow members to be used in additional applications. As previously stated, such a system produced by the systems and methods described herein may tend to have improved corrosion resistance and wear resistance.

First, regarding corrosion protection, the resulting metallurgical bonded enhanced metal alloy or composite layer tends to improve the corrosion resistance of the body to which it is applied. The corrosion protection may extend to other nearby bodies and may not be limited to the immediate area of coverage. The applied layer may provide resistance to galvanic corrosion by changing the galvanic potential of the system either locally or globally. The applied layer may provide anodic protection by acting as a corrosion barrier or by corroding preferentially, thus preserving the base material. The applied layer may provide cathodic protection by providing an electrical path to allow for the application of an impressed current or by providing a secondary reaction that counteracts the current developed in the primary corrosion reaction. The applied layer may provide protection by acting as an environmentally inert barrier between the protected base material and the reactive environment.

Second, regarding wear protection, the applied layer may take the form of a hard monolithic material in order to improve the resistance of the system to abrasive or sliding type wear. The applied layer may take the form of a ductile material for the purpose of improving resistance to wear caused by impact. The applied layer may be formed by a combination of hard particles and ductile matrix to further improve the resistance of the system to wear.

And finally, combined protection may be obtained with linings produced by the systems and methods described herein. The applied layer may be made by combination of wear protective components and corrosion protective components like a composite layer with softer corrosion component and harder wear component. Corrosion component can be any of corrosion resistant alloys and wear component is of any of hard ceramics component. Ratios of components can be changed based on required “master” properties.

In general the examples of linings 206 described herein may be applied to providing protection to the inner surface of goods such as: pipes, tubular goods and other elongate, hollow members, hereinafter referred to as “pipes” or “goods”. The protection provided is typically by disposing a lining to an interior surface of these goods. Such goods may be used in exemplary applications such as transportation of chemicals or raw materials, hydraulic actuators, structural risers, or structural tubular beams, or the like. In such applications the inner surface of the hollow member may be exposed to conditions which may cause degradation, wear and the like.

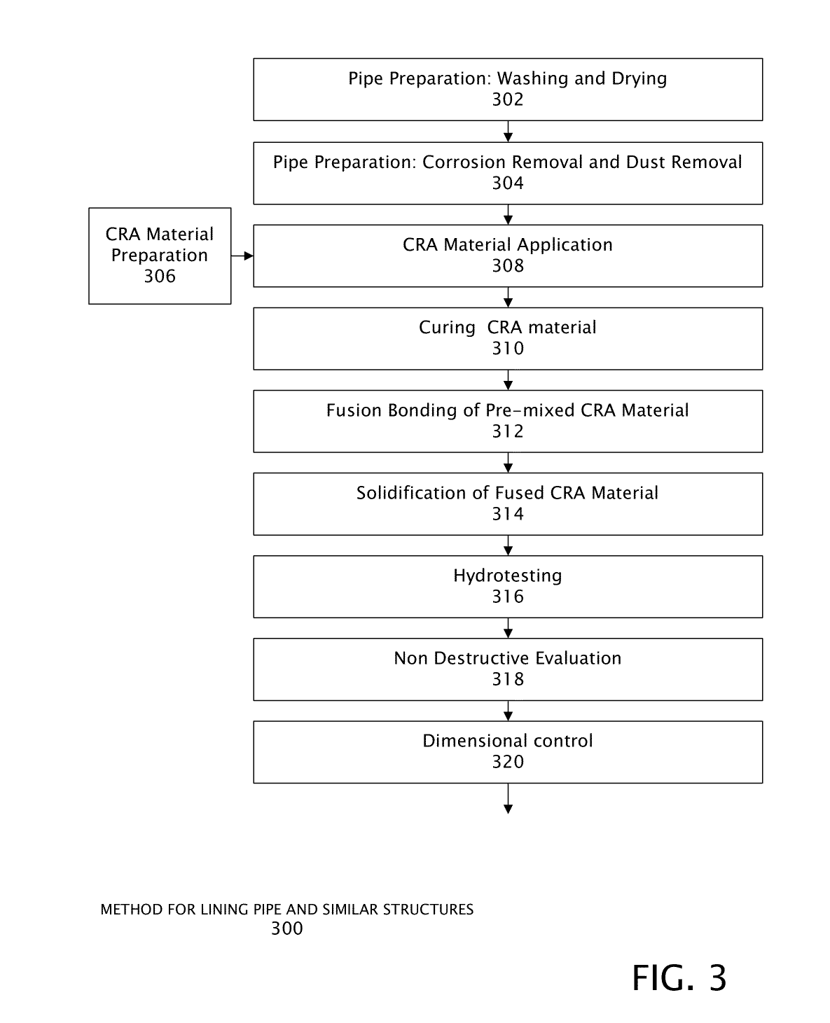

FIG. 3 is an overall process flow diagram for producing lined pipe and similar structures 300. The blocks in the process flow diagram may be described in further detail in subsequent sub-process diagrams. Typically pipe is procured and brought to the processing area. Such pipe may have been exposed to the elements, may be old, or otherwise in need of surface preparation before applying the lining.

At block 302 the pipe may be washed and dried by conventional machinery. The pipe inner surface, and optionally the outer surface may be washed and dried. The degree of washing and drying may be varied depending upon the condition of the pipe. Typically the pipe is held in a rack while a washing head on an elongate member is inserted into the pipe to apply a suitable cleaning agent, possibly with abrasion or scrubbing also provided.

At block 304 corrosion removal and dust removal may be done. Existing corrosion may be removed from the inner surface of the pipe. And dust and contaminants from the corrosion removal process may be removed from the pipe, utilizing conventional equipment.

At block 306 preparation of pre-mixed CRA (“chemical resistant alloy”) material is done. The CRA material for deposition onto the inner surface is prepared, mixed, and delivered to the apparatus for later application to the inner surface of the pipe.

At block 308 uniform application of pre-mixed CRA material to pipe inner surface is performed. The pre-mixed CRA material that was prepared may be applied substantially uniformly to the inner surface of the pipe, and smoothed to assure a consistent thickness. After or during application the pipe may be rotated to aid in evenly distributing the applied material, preventing it from sagging and the like until it is cured.

At block 310 the CRA material is cured. The curing of the CRA material 310 may include heating of pipe and providing ventilation. Curing the pre-mix prepares the pipe for fusing of the cured CRA material to the inner surface of the pipe.

At block 312 fusion bonding of the premixed CRA material to the pipe inner surface is performed. High temperatures via a heating device typically carried on an elongate member fuse the CRA to the metal of the pipe.

At block 314 solidification of fused CRA material occurs.

At block 316 hydrotesting 316 or hydraulic pressure testing is performed, non-destructive evaluation 318 is done to evaluate lining thickness, surface defects, porosity, and bond defects, among other quality measures. Finally, at block 320 dimensional control is done to make sure that the lined pipe has met is specified measurements.

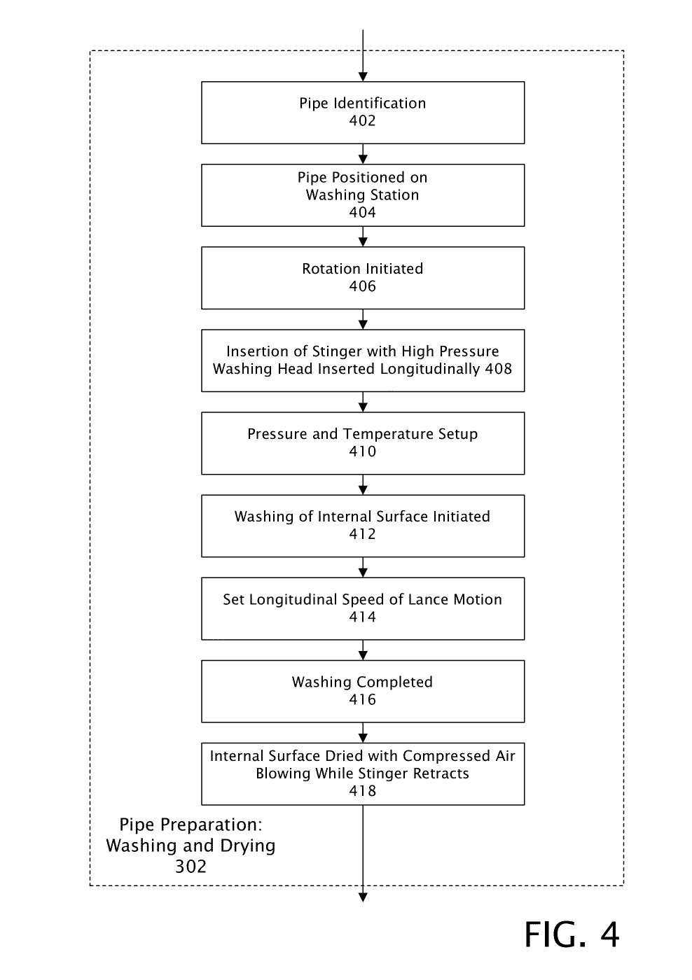

FIG. 4 is a sub-process flow diagram showing further detail of the pipe preparation, washing and drying process (301 of FIG. 3). Pipes, tubes, or hollow members typically having an inner surface to be lined and needing to be cleaned from salts, oil, grease, and impurities are selected for processing 402. The selected pipe is then positioned in the washing station at block 404.

Rotation of the pipe 406 is commonly used to facilitate cleaning. Also, it is not necessary to clean the external surfaces, but these may also be cleaned if desired.

At block 408 a stinger with a high pressure washing head may be inserted into the pipe. Next, at block 410, pressure and temperature of the washing or cleaning solution is set up.

At block 412 washing is initiated. Next t block 414, the speed of the lance moving longitudinally along the axis of the pipe may be set.

Cleaning may be performed by hot water and or cleaning agents. Use of water vapor, high pressure water washing, or high pressure water washing with addition of commonly used detergents, and the like is recommended. Use of commercially available equipment may be used as a washing station.

In cleaning, inclination of the pipe is generally used to ease removal of liquid residue. Inside diameter pipe washing systems are generally used with high pressure and elevated temperatures.

After cleaning is completed at block 416, the pipe is dried at block 418. Hot air or pipe heating is generally used to aid drying. Sufficient time for proper drying is provided. The length of time required typically depends on the particular washing method used and environment conditions, such as humidity and temperature. The cleaned pipe is now ready for the removal of corrosion and dust in the second cleaning process.

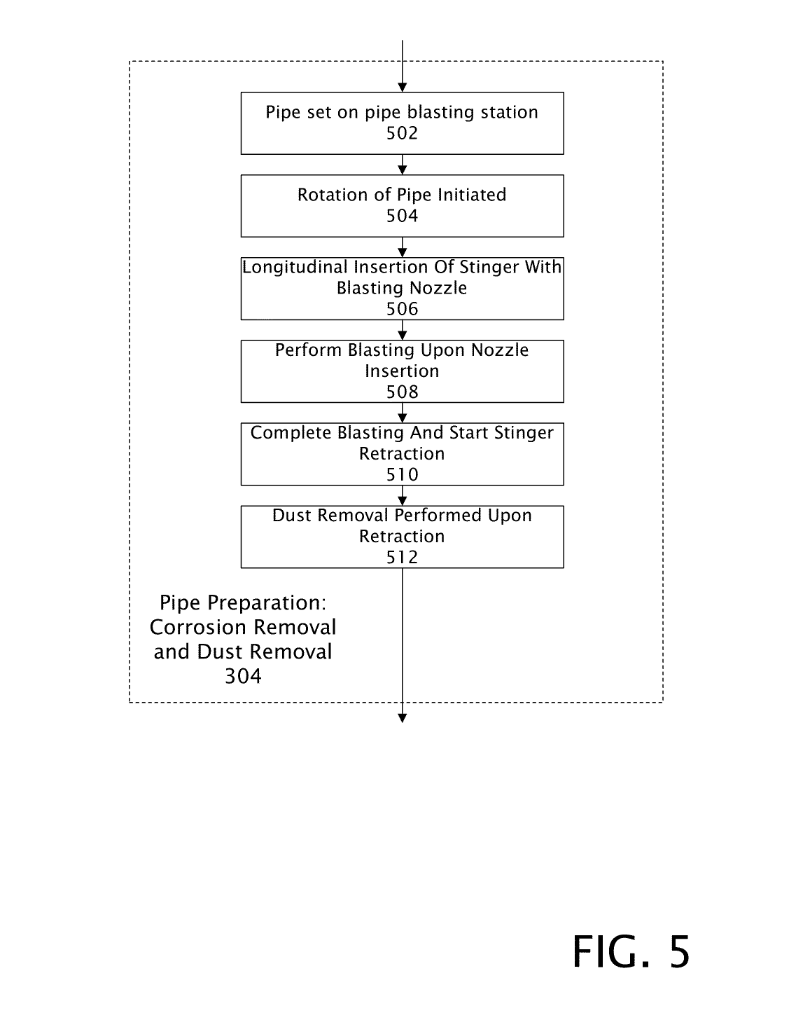

FIG. 5 is a sub-process flow diagram showing further detail of the pipe preparation including corrosion and dust removal (304 of FIG. 3) process. Pipes, tubes, or hollow member's internal surface corrosion deposits are removed by any suitable methods to achieve sufficient surface preparation level and required surface profile. The level of removal of corrosion deposits required is such that the majority of corrosion deposits are removed. Generally “near white metal” or better level of cleaning may be used. Use of steel grit blasting and the like is used to provide required level of surface preparation. Conventional air blasting systems for pipe inner surfaces are generally used.

At block 502 the pipe goes to the pipe blasting station for a second stage of cleaning. At block 504 optional rotation of the pipe is initiated. At block 506 the stinger with a blasting nozzle is inserted into the pipe, and blasting is initiated at block 508 using an appropriate abrasive.

During blasting the specified inner surface thickness profile depends on the thickness of pre-mix CRA material to be applied. The required surface profile is achieved with appropriate abrasive size, hardness, and air pressure. Generally, roughness in the range of 20-100 μm is required.

Also during blasting the control of atmospheric conditions may be needed during processing to prevent “flash rust” formation during process. Generally low (>40%) humidity environment is good practice. Generally after cleaning corrosion deposits, application of the CRA is depositing of material is done within about 1 hour. Re-treating for corrosion deposits is recommended if longer time passes.

At block 510 the blasting is complete. When blasting is complete, the stinger is removed from the pipe.

At block 512 dust removal using a light acid wash solution is optional after grit blasting to assure a good surface for application of pre-mix CRA material. The acid wash operation is used to remove chlorides and other contaminants from the surface of the pipe before being heated and Pre-mix material deposited. Acid is applied through metered pumps and washed off with high-pressure de-ionized water prior to entering the heating furnaces.

It is not required to clean the outer surface of the pipe, but is highly recommended. Light “commercial grit blasting” is recommended method. Any other suitable method may be used. Outer surface cleaning may be useful for uniform heat transfer as well to have uniform surface for temperature monitoring.

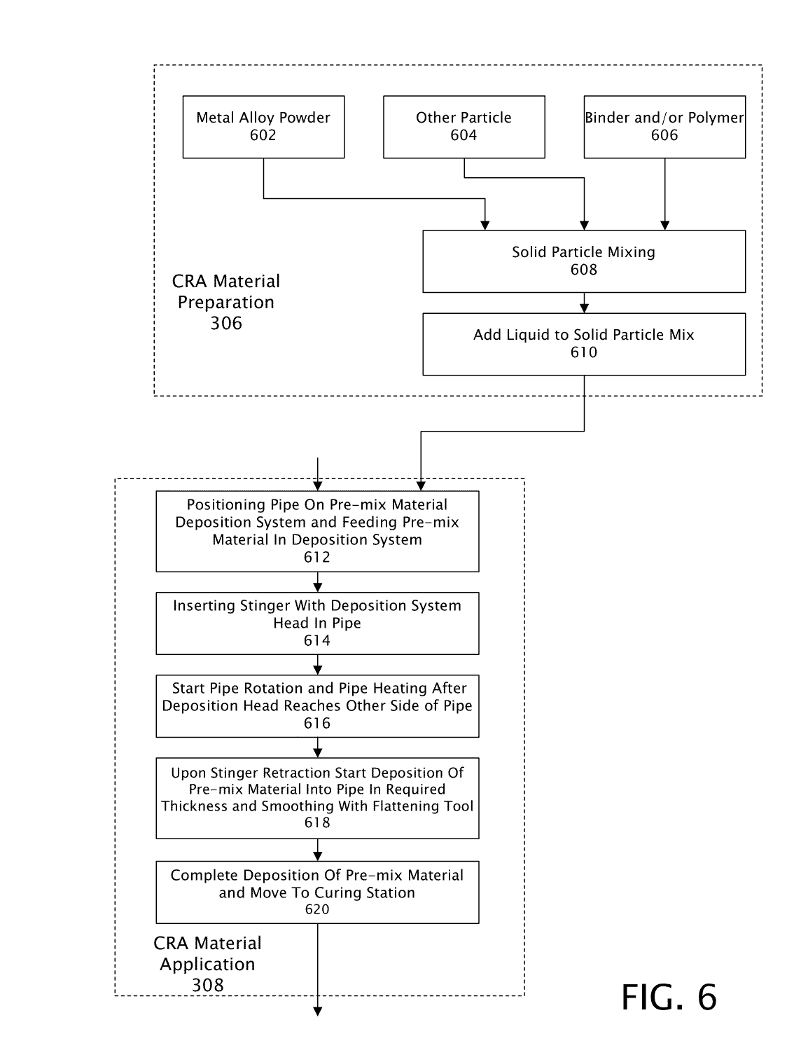

FIG. 6 is a sub-process flow diagram of the CRA material preparation process (306 of FIG. 3) and the CRA material application (308 of FIG. 3) process. The CRA Material Preparation Process 306 will be described first. The pre-mix metal or composite is prepared for deposition, by mixing solid particles and adding solvent afterward to achieve the required density and viscosity suitable for application method. Generally, the use of commercial mixers and mixing methods are used, such as a high shear mixer, or the like.

Generally, for a spray method of applying the CRA material to the pipe interior is used, solid particles are in range up to about 100 μm diameter and particle size distribution varies. If a paste method of applying the CRA material to the pipe interior is used, a wide distribution of particle size might be used, with particle sizes generally up to about 5 mm. Solid particles can be metal, organic binder, polymer, ceramic, or any combination thereof.

The pre-mixed metal powder or composite deposit can comprise a metal, polymer, ceramic, or any combination of materials thereof. Generally, material used are UNS 06625, UNS 08825, SS 316L, and the like. The included ceramic material, if any, may be formed in situ, existing in the precursor material as a metal or pre-ceramic polymer. Materials typically used are tungsten carbide, chromium carbide, silicon carbide, titanium nitride, and similar materials.

At block 602 metal alloy powder is added to the mixer. Generally metal particles, or metal alloy powders are nickel based alloys, stainless steels, copper alloys, titanium alloy, or similar. Generally, all metals with melting points up to about 1700° C. may be used.

At block 606 binders and or polymers are added to the mixer. Binders generally can be any that provide sufficient adhesive and thixotropic properties. Materials such as polyethylene glycol, xanthan gum, welan gum, or similar can be used. If called for, polymers can be generally urea-formaldehyde, melamine, or similar.

At block 606 other particles can be added to the mix. These particles can include ceramics, tungsten carbide, silicon carbide, titanium nitride, or similar.

Once the solid particles are mixed 608, solvent may be added 610. The solvent can be water, ethanol, isopropanol, binder solution, or any combination thereof.

Heating of solid particles or solvent can be used to facilitate mixing and homogeneity of the pre-mix material. Heating of the pre-mix material can be used to change the properties of the pre-mix material, thereby providing benefits with respect to conveying, drying, curing, or other benefits

Pre-mix material is generally in range from 30-65% dense, but lower or higher density pre-mix may be made, if necessary. In this case density means that the premix material is not of full density (there is porosity and voids between the particles) and will become almost fully without voids during fusion process (some porosity is typically always present to a degree) Viscosity is generally in range from 600 to about 500,000 cP and depends on application method. Lower viscosities are generally used with spray application where higher viscosity is generally used with paste application.

Based on type of deposited material, different properties are achieved, and based on the requirements of the finished product, different layers of deposited materials may be made.

The deposited material is applied to the internal surface of the tube, pipe, or hollow member. After heating the deposited material may take the form of a fused enhanced metal alloy or composite. The deposited material is applied to the inner surface of the hollow member prior to fusion and may take the form of a pre-mixed metal powder or composite, foil, tape, sheet, or similar form.

The pre-mix material is applied to the inner surface of a pipe by depositing it onto the cleaned internal surface of the pipe, tube or hollow member. Application is performed using spray method or paste method, depending on the desired thickness and material composition of the paste to be applied. Generally, metal materials with a thickness less than about 0.5 mm are applied by spray method, whereas the paste method is used for greater thicknesses and or composite materials. With the methods and apparatuses described herein it is possible to apply typically uniform paste thicknesses from 100 microns, to 4 millimeters in thickness, per paste application.

At block 308 the CRA material application process applies the mixed material prepared at block 306 to the pipe interior. At block 612 application begins by placing the pipe on the pre-mix material deposition system and feeding the pre-mix material to the system for application to the pipe interior. At block 614 the stinger includes the paste dispensing head or sprayer and is inserted into the pipe until it reaches the end of the pipe. Paste is not yet dispensed. At block 616 rotation of the pipe and heating of the pipe is preformed prior to dispensing the paste on the interior of the pipe. The pipe may be rotated during deposition of the pre-mix to improve deposition uniformity.

At block 618 after insertion of the stinger with the deposition head into the pipe, the pre-mix material is applied to the interior surface of the pipe by using spray or paste deposition. Deposition is performed as the head is retracted from the pipe. The thickness of the deposited pre-mix material is based on the desired metallurgical bonded enhanced metal alloy or composite thickness and pre-mix material density. At block 620 deposition of the paste on the interior of the pipe is complete, and the pipe with the paste lining may be moved to the curing station,

The pre-mix material may be deposited in thicknesses from about 0.05 mm to about 8 mm, depending on the desired final thickness. The application method is determined by pre-mix material solid particle size and distribution and pre-mix material viscosity. Generally, lower viscosity materials are used for spray application. If the pre-mix material is applied by spray, use of typical commercially available atomization equipment may be used, such as airless or air assisted systems are used. The atomization nozzle is determined based on pipe size and a 360° type nozzle is generally used on pipe below about 4″ inside diameter.

Larger solid particle size and higher thicknesses of required metallurgical bonded enhanced metal alloy or composite are generally applied by the use of paste deposition. Control of deposited thickness is obtained by control of linear process speed and pre-mix material flow. When the paste application method is used, extrusion of the paste is performed by any suitable way, such as commercially available auger, extruder, progressive cavity pump, cylinder pump, or the like.

The extruded material is distributed with a smoothing plate or cylinder. The thickness of the deposited material is controlled by the size of smoothing plate 618 or cylinder with respect to the base pipe. The uniformity of the thickness of the deposited pre-mix material is enhanced by pipe rotation 616. The pipe is moved to the curing station 620.

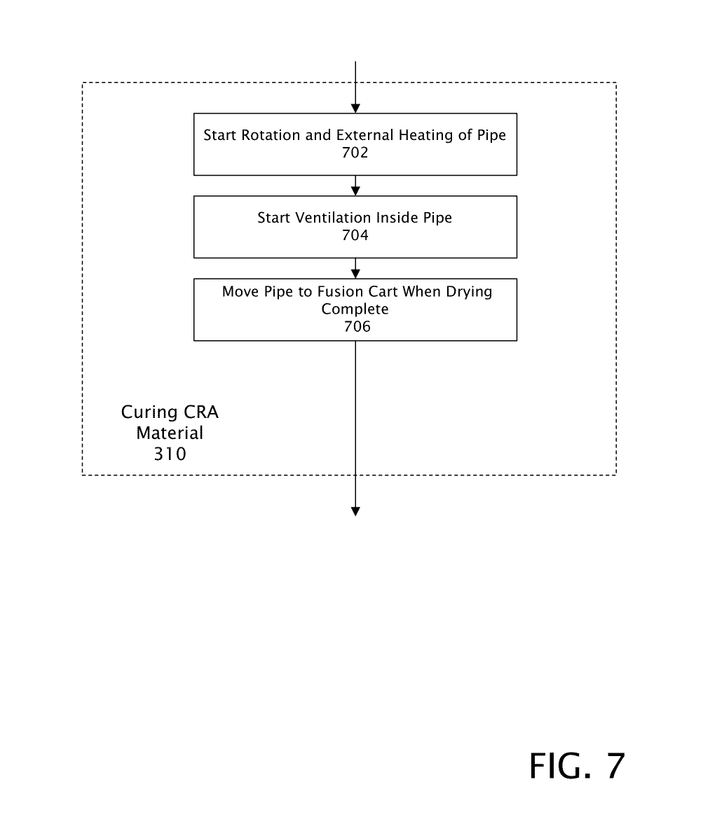

FIG. 7 is a sub-process flow diagram of the curing CRA material (310 of FIG. 3) process. At block 702 rotation and external heating of pipe may be used to enhance the curing of the deposited material. The pipe is optionally rotated. The preheating temperature depends on the pipe size and required deposited pre-mix material thickness. After the pre-mix material deposition on inner surface of the pipe, curing of deposited pre-mix material is required.

The time required for curing depends on the pre-mix material deposit thickness, solid particle content, solvent type, and curing method used. Curing is enhanced by heating of the pipe, and air flow. Heating can be done by utilizing any heating source available; induction heating, flame, and hot air are common sources of heat. Heating temperature depends on thickness of deposited Pre-mix material and it composition. Generally, the heating temperature is in range of about 70-110° C. Curing can be done in a heating chamber or low temperature furnace.

At block 704 forced, or suction ventilation may be used for evacuation of solvents during curing process. The pipe is then moved to the fusion station 706.

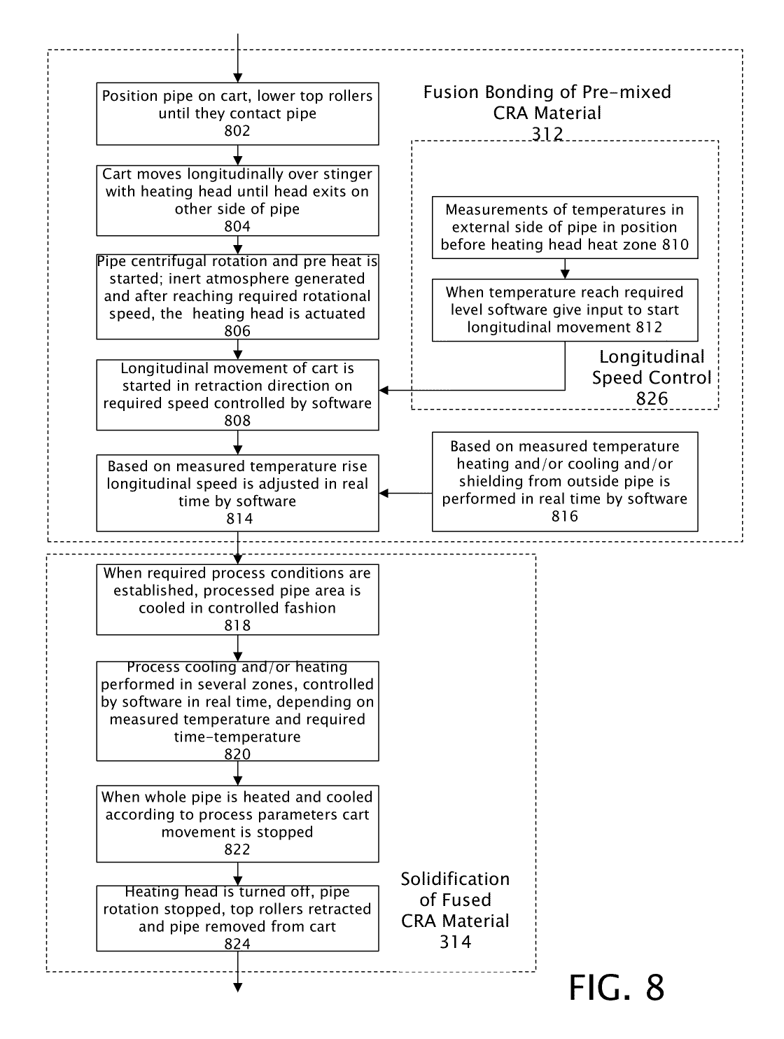

FIG. 8 is a sub-process flow diagram of the fusion bonding of CRA material (312 of FIG. 3) process, and the solidification of fused CRA material (314 of FIG. 3) process. The fusion bonding process 312 will be describe first. Regarding fusion, a metallurgical bonding of deposited Pre-mix material is obtained with use of uniform heat applied on deposited Pre-mix material. The heat source may be produced by a lamp array. Lamps used in the array may generally be of the gas sealed plasma arc lamp type.

At block 802 the pipe with deposited and cured pre-mixed material is positioned on fusion cart. Retaining top rollers may be lowered to contact the pipe to hold it in place while it is rotated during processing.

At block 804 the pipe on the cart is moved longitudinally until the lamp array passes through the pipe and exits the opposite end.

At block 806 pipe rotation and preheating is started. Preheat of pipe is generally done about 300 mm in front of lamp array-heated area, but shorter or longer distance for preheating may be used, if necessary. During this process a shielding gas may be introduced into the pipe to generate an inert atmosphere during processing. A shielding atmosphere can be generated inside pipe. Alternatively This process can be done with whole pipe inside shielding atmosphere, by having it inside a chamber. The shielding gas is intended to provide an inert atmosphere, and generally, any of a variety of standard shielding gases used for welding process might be used. Sampling and control of the inert atmosphere may be performed during the metallurgical fusion bonding process.

When the desired rotational speed is achieved the lamp array is ignited and brought to a power level sufficient for fusing. The rotational speed generally depends on pipe, tube or hollow member size and enhanced metal alloy or composite required thickness. Rotation is used to generate sufficient centrifugal force to keep liquid metal alloy or composite from flowing to bottom of pipe, tube or hollow member due to viscosity change and gravitational force. Generally rotational speed is in the range of about 200 to about 1600 rpm but slower or faster speeds may be used taking in account that sufficient force is generated.

Rotation, in combination with melting as result of heat generated by the lamp array in 360° direction creates uniform layer of enhanced metal or composite material. Centrifugal pressure created with rotation art a sufficient speed improves the material contact with the base pipe, thereby generating a more dense material with reduced porosity, and pushing impurities and oxides to surface. Alternately, depending upon the composition of the CRA or metal alloy, as a method to maintain position of the applied CRA or metal alloy material upon exposure to fusion temperatures, the use of magnetic attraction with or without rotation can be employed. Magnetism may be used to generate sufficient force to provide liquid metal alloy or composite from flowing to the bottom of the pipe due to viscosity change and gravitational force. Generally electro magnets are used but permanent magnets can be used as well.

With control of liquid metal temperature and/or rotation and/or magnetic force, a high level of control of grain size in the lining can be achieved. Higher rotational speeds and/or stronger magnetic force provide more refined grain structure, as well reduce dendritic growth and a more beneficial microstructure for corrosion resistance.

Rotation and/or magnetic force additionally provides high level of uniformity of enhanced metal layer in conjunction with higher bond strength and reduce level of nonbonding defects. Once the section of pipe being bonded has been sufficiently radiated. The lamp head is moved to the next section to be fused.

At block 808 when the temperature is reached, cart movement is enabled and the cart starts to move longitudinally at the determined process speed. Generally, longitudinal speed is based on pre-mix material type, thickness, and pipe type and diameter. Normally, speed is in range of about 60-900 mm/min but other speeds may be used if required. Speed is not necessarily set to a predetermined feed rate. Speed may be adjusted based on various process control parameters used to form a feedback control loop.

Longitudinal speed control 826 may be done in real time by measuring desired parameters that determine when fusion in a section may be complete and when the fusion lamp may be moved, and how fast it may be moved. Longitudinal speed control may be provided by sub processes 810, and 812.

At block 810 monitoring temperatures during process at all desired monitoring points is performed. If needed by process design, the pipe can be preheated by any applicable way during this initial phase of fusion process. Generally, low frequency induction may be used for the preheat process. The temperature of preheat varies and is based on the type of base pipe type and diameter, and generally is in range from about 100-350° C.

In particular at block 812, when temperatures reach a desired level the signal that longitudinal movement may commence is coupled to block 808.

At block 816 monitoring of the process may be done at every step of process to control movement of the lamp so that an acceptable lining is produced. Generally time-temperature is the main process requirement. Temperature monitoring is performed on the outside and inside of the pipe in different positions. Based on the required process parameters, temperature measurement is used to adjust, in real time, longitudinal speed, power, preheating, heating during process, and cooling after process, or any combination of thereof.

During the heating process, the deposited pre-mix material is heated to or above its liquid phase temperature. Additionally, the pipe internal surface is heated to the required process temperature. Depending on the required interface temperature, it might be required to heat in whole thickness.

Pipe may be typically supplied from a manufacturer in a “green” condition, not having any heat treatment applied in order to change its strength properties. Heat treatment in order to impart strength characteristics to the pipe may be done in combination with the lining process, as a desired heat treatment profile may be simultaneously applied during lining. This combination processing advantageously saves an additional heat treatment step from having to be performed, as lining and the heat treatment for mechanical strength in the base pipe material may be accomplished in the same process.

Monitoring of the liquid metal temperature and pipe outer surface is performed. Generally, non-contact temperature measurement methods are used such as infrared, blackbody optical fiber thermometer, radiofrequency, or the like.

Maintaining the required process parameters may require control of energy radiation loss, thus, cooling or heating may be applied to maintain. Cooling is done with forced or compressed air and/or water. Heating, if necessary can be done with any suitable method; however, low frequency induction heating is typically used. Energy radiation loss can be minimized by any suitable mean; generally local insulation shielding is used.

At block 814 longitudinal movement controlled by process feedback 818 based on sensor readings creates a continuous process on 360° of the inner surface of pipe, creating a uniform lining throughout the entire length of the pipe. Next with the lining is cooled in the solidification of fused CRA material process 314.

Solidification of the fused CRA material is next carried out in block 314. The solidification and cooling process begins as the heated area of pipe exits from heating energy field of the lamp array. Internally, a shielding gas might be used to enhance solidification process of enhanced metal alloy or composite. Generally pressure, flow, and temperature is monitored. Pressure used is in range of about 20-125 psi, flow in range of about 1-20 lit/min and temperature from about 10-50° C., but other parameters can be used if required by time-temperature requirements.

At block 818 based on designed process conditions, combinations of different cooling options may be established. In this block the processed pipe area may be cooled in a controlled fashion.

At block 820 process cooling and or heating may be performed in several zones. Control is provided based on an established time and temperature profile as compared to measured temperature values. Generally external water cooling on 360° surface of pipe in specific zone or zones 820 with control of flow, pressure, and temperature for each zone is used. Air cooling can be used alone or in combination with water in some or all zones.

The cooling process may be monitored by temperature measurement in different zones from both outer and internal side of pipe or hollow member. Controlling software may be used to change process parameters based on sensor readings.

At block 822 when the entire pipe is heated and then cooled according to process parameters, the cart stops movement. At block 824 the pipe is removed from the cart.

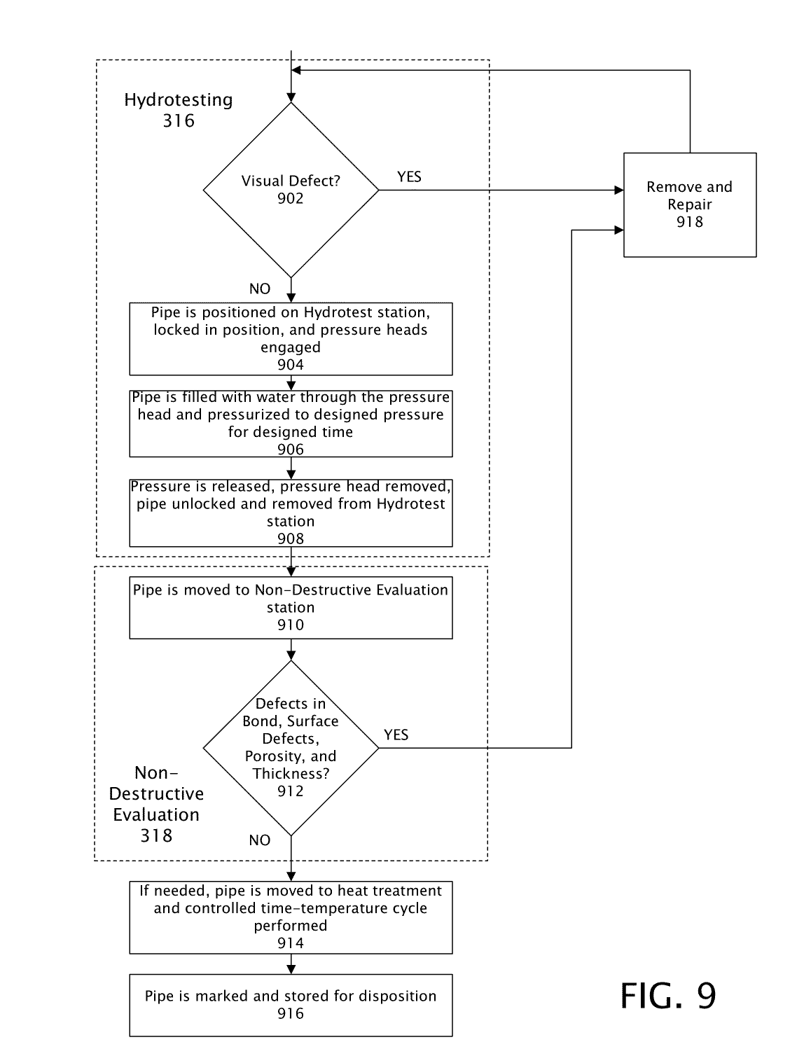

FIG. 9 is a sub-process flow diagram of the Hydrotesting process (316 of FIG. 3), the non-destructive evaluation process (318 of FIG. 3), and Dimensional control processes (320 of FIG. 3). Additionally when defects are encountered, the pipe may be removed from the process flow and repaired at block 918. Finally heat treatment 914 is provided and the pipe is then marked and stored 916.

Once the whole pipe is processed for fusion and cooled top rollers are lifted and the pipe, is removed from fusion cart.

At block 902 the processed pipe is visually examined for defects. If non-acceptable defects are found, the pipe is removed for repair 918. If there are no defects the pipe is passed to the hydrotest station in block 904 where it is locked into position, and the pressure heads are engaged. The hydro testing and pressure testing station are designed to pressure test the lined pipe. Generally commercially available hydro testing equipment is used.

At block 906 the pipe is filled with water through the pressure heads to a specified test pressure. The pressure may be maintained at the specified pressure for a specified time. At block 908 the pressure is released, pressure heads removed, and the pipe is unlocked and removed from the hydrotest station.

Nondestructive evaluation 318 may be performed to verify quality of metallurgical bonding. Generally visual inspection, phased array ultrasonic testing and thickness measurement may be performed. The testing may be done with automated system or manually, generally using commercially available equipment. If defects in bond of the lining, surface defects in the lining, porosity in the lining, or thickness defects are found the pipe is removed and sent for repair 918. If no defects are found during nondestructive evaluation the pipe is ready for final processing.

Post heat treatment 914 may be applied next. Generally, the use of furnace heating followed with specified controlled cooling/heating process is used. If used, heat treatment is designed to provide a specific metallurgical structure required for intended use of pipe. Finally at block 916 the pipe may be marked, and stored for distribution, or disposition. In addition conventional dimensional control methods (320 of FIG. 3) may be applied to the finished lined pipe to ensure that it will provide a proper fit when used in a particular application.

All of the processes in the above description may be implemented manually, mechanically, under computer control, or a in any combination thereof. It is contemplated that computer control is the most advantageous way of implementing these processes, by a single controller or by a central controller with a plurality of distributed processors executing one or more processes under direction of the central controller. Accordingly, the processes may be segregated into individual programs, application programs, subroutines or the like suitable for programming and execution on one or more processors. Any suitable programming language may be used to implement these processes, including high level, or object oriented programming languages, machine code or the like. Coding of the above mentioned processes may be accomplished by conventional programming techniques for a given computing set up.

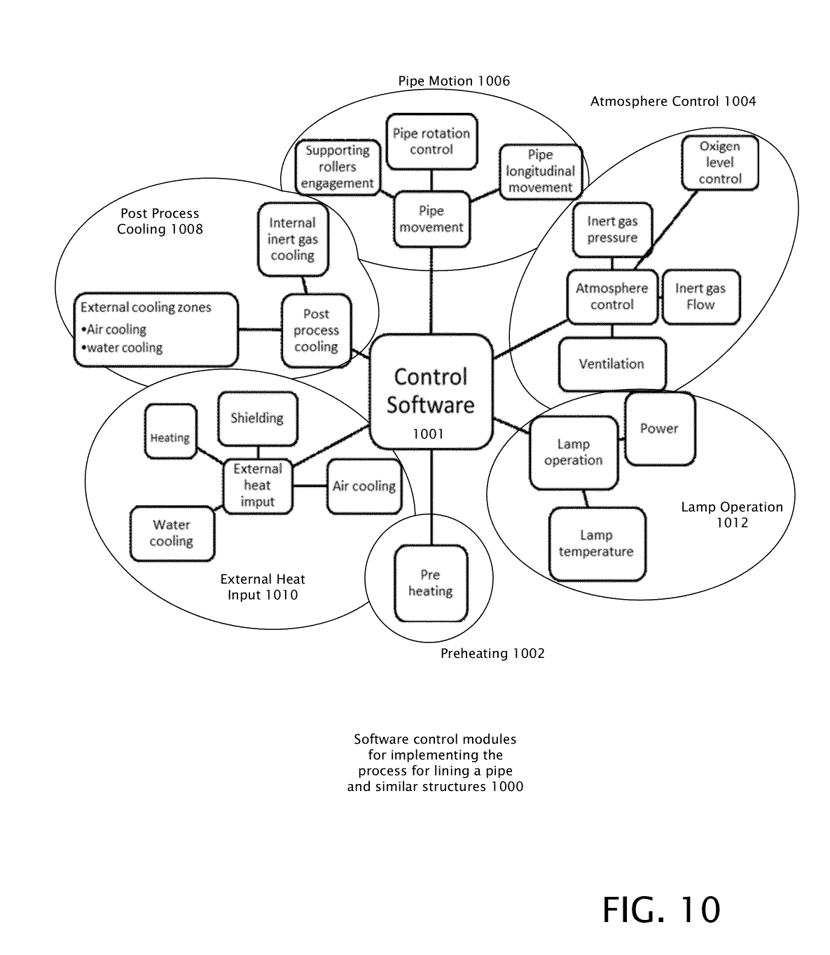

FIG. 10 is a block diagram 1000 showing various control software modules that may be utilized to execute the method for lining a pipe and similar structures. The software control modules may be executed by a single controller, or alternatively may be loaded into remote programmable control modules for execution under the direction of a central processor. These software modules are exemplary and are representative of the functions that may be provided to execute the processes described above in machinery that is controlled by one or more processors.

Control software 1001 is used to control fusion process and obtain required process conditions. The control software (CS) 1001 manages fusion process conditions input designed for specific pipe, tube or hollow member with deposited enhanced metal alloy or composite for all required elements, get readings from process monitoring sensors and provide outputs to change variables that affect fusion process. Sensors utilized in controlling the process are generally temperature sensors, speed sensors, power sensors, flow sensors, inert atmosphere quality and/or similar. Continuous control of the process is performed from start till the end of processing each pipe, tube or hollow member.

Inputs to the control software are designed to monitor fusion process conditions required for generating desired product properties. Generally Inputs to the control software include rotational speed, inert atmosphere conditions, lamp power, preheat temperature, liquid metal temperature, external pipe, tube or hollow member temperature in several positions, cooling time temperature curves for internal and external surface. Additional Inputs are used if desired to provide desired optimum fusion process.

Outputs generated by the control software provide parameters to process equipment that adjust variables that affect process outcome. Generally variables that can be adjusted are rotational speed, longitudinal movement speed, inert gas pressure, inert gas flow and distribution, pre-heat, radiation loss control, cooling in heated area, after process temperature control, ventilation. Other Variables might be included if desired. Various software modules that are conventionally constructed to process and direct these inputs and outputs in the control software 1001 are also shown.

Atmosphere control 1004 may include modules to control: the oxygen level, inert gas pressure, inert gas flow and ventilation. Lamp operation 1012 may include the control of power and lamp temperature. Preheating 1002 may also have a dedicated software module for its control. External heat input 1010 may include the control of water cooling, air cooling, heating, and shielding. Post process cooling 1008 may include control of internal inert gas cooling, and the control of the external cooling zones of air cooling and water cooling.

Pipe motion control software modules 1006 additionally control roller engagement, positioning of sensors relevant to heated area, positioning of equipment that control Variables and engagements of the equipment.

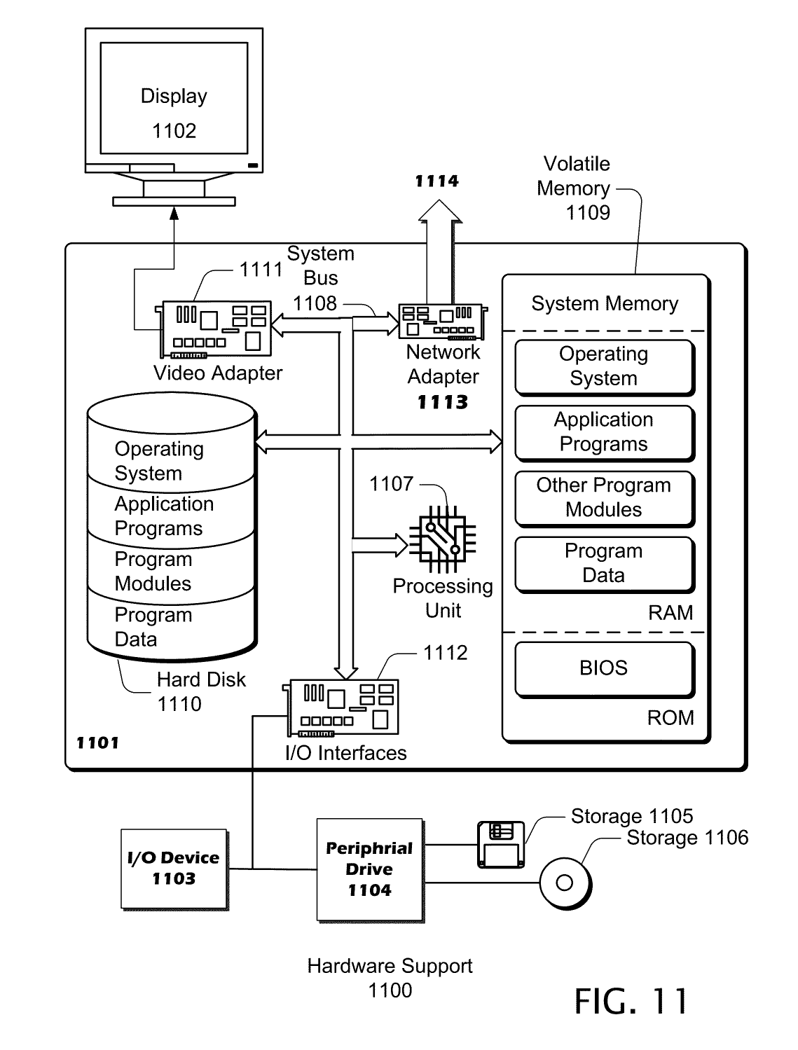

FIG. 11 illustrates an exemplary computing environment 1100 in which the process for producing lined pipe described in this application, may be implemented. Exemplary computing environment 1100 is only one example of a computing system and is not intended to limit the examples described in this application to this particular computing environment.

For example the computing environment 1100 can be implemented with numerous other general purpose or special purpose computing system configurations. Examples of well-known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 1100 includes a general-purpose computing system in the form of a computing device 1101. The components of computing device 1101 can include one or more processors (including CPUs, GPUs, microprocessors and the like) 1107, a system memory 1109, and a system bus 1108 that couples the various system components. Processor 1107 processes various computer executable instructions, including those to implement the method for lining a pipe and similar structures and to control the operation of computing device 1101 and to communicate with other electronic and computing devices (not shown). The system bus 1108 represents any number of several types of bus structures, including a memory bus or memory controller, a peripheral bus, an accelerated graphics port, and a processor or local bus using any of a variety of bus architectures.

The system memory 1109 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 1107.

Mass storage devices 1104 may be coupled to the computing device 1101 or incorporated into the computing device by coupling to the buss. Such mass storage devices 1104 may include a magnetic disk drive which reads from and writes to a removable, nonvolatile magnetic disk (e.g., a “floppy disk”) 1105, or an optical disk drive that reads from and/or writes to a removable, non-volatile optical disk such as a CD ROM or the like 1106. Computer readable media 1105, 1106 typically embody computer readable instructions, data structures, program modules and the like supplied on floppy disks, CDs, portable memory sticks and the like.

Any number of program modules can be stored on the hard disk 1110, Mass storage device 1104, ROM and/or RAM 1109, including by way of example, an operating system, one or more application programs, other program modules, and program data. Each of such operating system, application programs, other program modules and program data (or some combination thereof) may include an embodiment of the systems and methods described herein.

A display device 1102 can be connected to the system bus 1108 via an interface, such as a video adapter 1111. A user can interface with computing device 702 via any number of different input devices 1103 such as a keyboard, pointing device, joystick, game pad, serial port, and/or the like. These and other input devices are connected to the processors 1107 via input/output interfaces 1112 that are coupled to the system bus 1108, but may be connected by other interface and bus structures, such as a parallel port, game port, and/or a universal serial bus (USB).

Computing device 1100 can operate in a networked environment using connections to one or more remote computers through one or more local area networks (LANs), wide area networks (WANs) and the like. The computing device 1101 is connected to a network 1114 via a network adapter 1113 or alternatively by a modem, DSL, ISDN interface or the like.

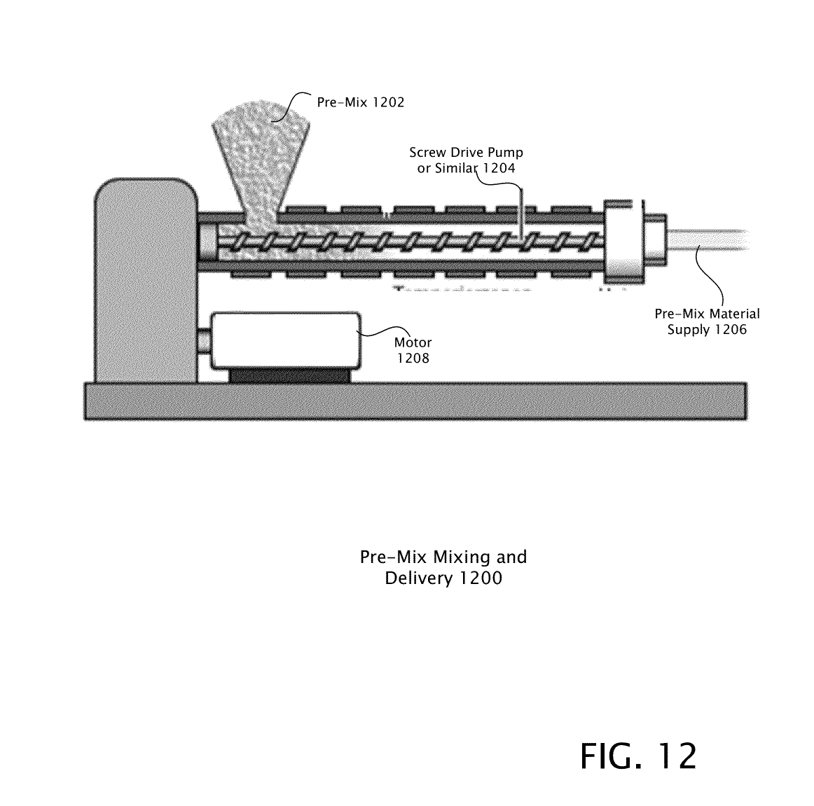

FIG. 12 shows an apparatus for mixing and delivering uncured lining material 1200. The uncured pre-mix lining material components and solvent are mixed in a conventional mixer (not shown) and pre-mixed material 1202 can be placed in hopper attached to a materials pump, such as a screw drive pump 1204 or equivalent. Although a screw-drive pump, or auger, is shown, any suitable pump and system for handling slurry-type or paste materials may be used, such as an extruder, progressive cavity pump, cylinder pump, or similar. The pump may be driven by the motor 1208 which rotates the screw drive pump 1204, pushing the pre-mix lining material through the pre-mix supply 1206 to the material delivery apparatus (not shown) for application to the interior of a pipe.

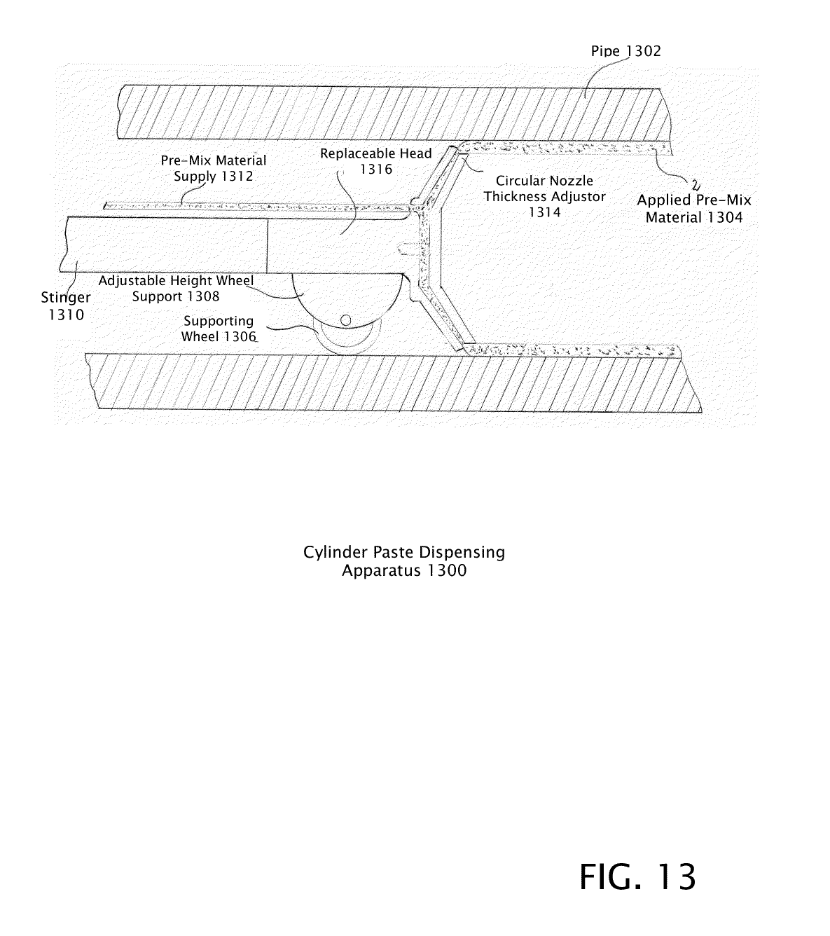

FIG. 13 shows an apparatus for applying the uncured pre-mix lining material to the interior surface of a pipe, tube, or hollow member 1300. A longitudinal section through the pipe, tube, or hollow member 1302 and the apparatus 1300 for applying the uncured pre-mix lining material is shown. The apparatus consists of a stinger 1310 to which a replaceable head 1316 can be removably attached. Different replaceable heads may be used for applying uncured pre-mix lining material to different diameter pipes.

An adjustable height wheel support 1308 and supporting wheel 1306 may be attached to the removable head 1316 to position the removable head in the diametric center of the pipe. One or a plurality of adjustable height wheel supports 1308 and supporting wheels 1306 may be used.

The replaceable head may be flared at its distal end to deliver the pre-mix lining material towards the inner surface of the pipe 1302. Attached distal to the flared end of the replaceable head is a cylindrical or circular nozzle thickness adjustor 1314. The circular nozzle thickness adjustor 1314 is removably attached to the replaceable head, and the space between the flared end of the replaceable head 1316 and the circular nozzle thickness adjustor 1314 can be varied, depending on the materials selected for the lining material, the desired thickness of the final layer, the pipe base material, among others. The surface of the circular nozzle thickness adjustor 1314 closest to the inner surface of the pipe 1302 smooths the applied pre-mix lining material 1304 as it is deposited, thereby providing a uniformly thick of applied pre-mix material 1304 with a smooth surface. Additionally, pipe rotation during application of the pre-mix lining material enhances the uniformity of the deposited material, and may keep the material from pooling at the bottom of the pipe.

In use, uncured pre-mix lining material is pumped through the pre-mix material supply 1312 along the singer and shaft portion of the replaceable head 1316 to the space between the flared end of the replaceable head 1316 and the circular nozzle thickness adjustor 1314. The uncured pre-mix lining material is forced through this space using an auger, extruder, progressive cavity put, cylinder pump, or similar (1200 of FIG. 12), to the inner surface of the pipe 1302. The spacing between the inner surface of the pipe 1302 and the diameter of the circular nozzle thickness adjustor 1314 determines the thickness of the applied pre-mix material 1304 and, in combination with pipe rotation, provides a smooth surface finish to the applied pre-mix material 1304 prior to curing.

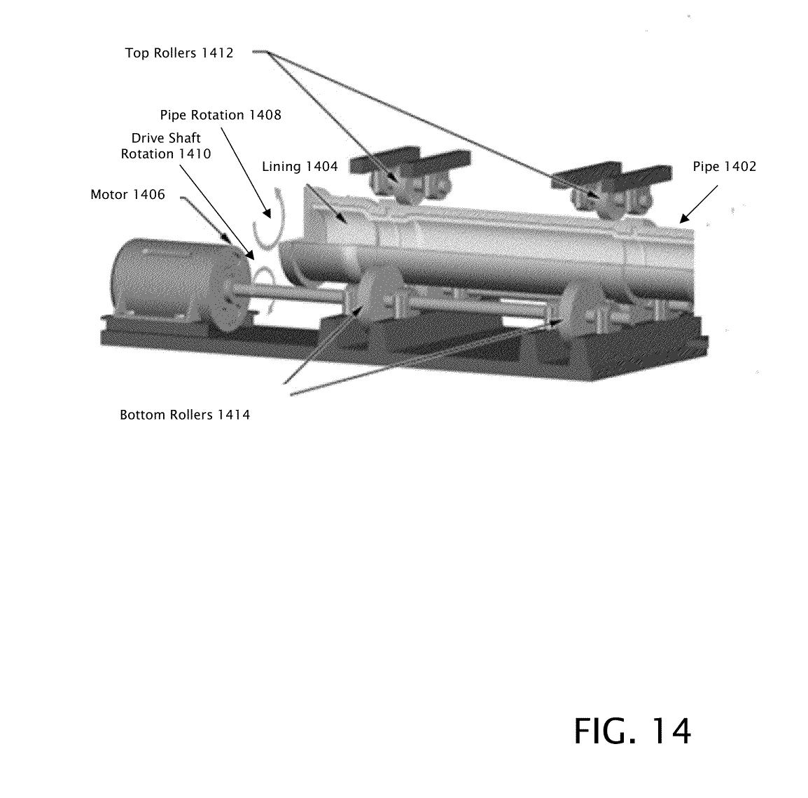

FIG. 14 shows an apparatus for rotating a pipe while the pre-mix lining material is curing. The pipe 1402 with uncured pre-mix lining material 1404 can be placed in a cradle defined by two pairs of bottom rollers 1414 and fixed in place by moving adjustable height top rollers 1412 into contact with the outer surface of the pipe 1402. A motor 1406 turns a drive shaft 1416 rotationally 1410. Rotation of the drive shaft causes rotation 1408 of the pipe 1402 in the opposite direction of the drive shaft 1416.

It is obvious to those skilled in the art that, depending on the length of pipe to be cured, additional bottom rollers 1414 and top rollers 1412 may be necessary to support the length of pipe 1402 to be cured.

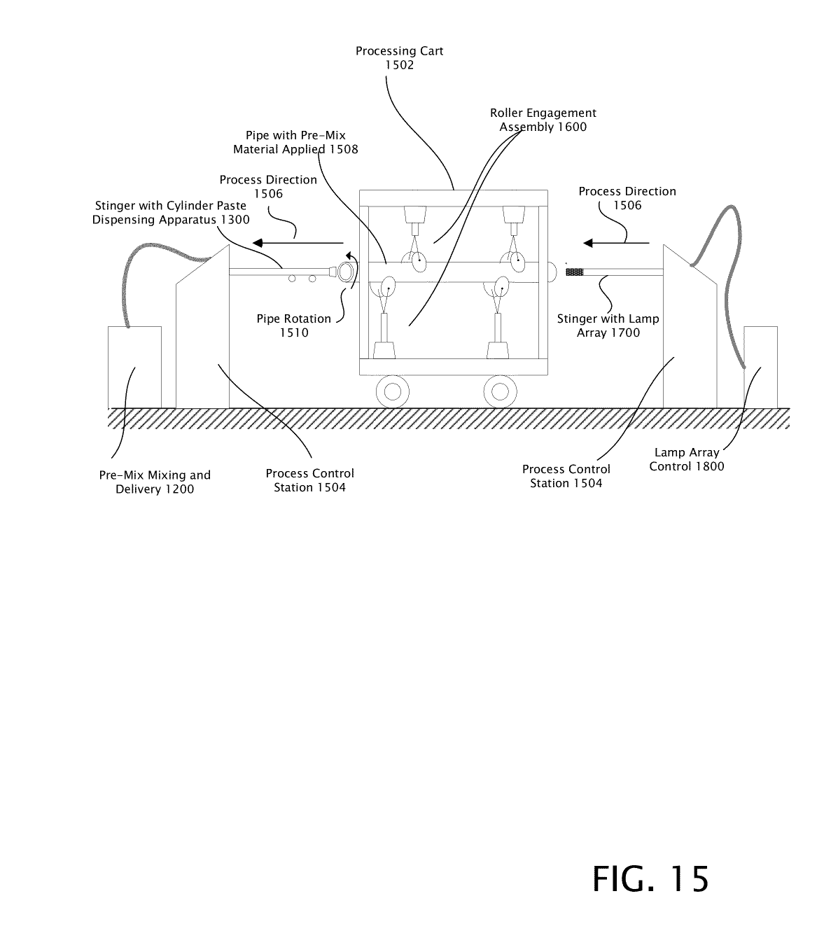

FIG. 15 shows the apparatus for rotating a pipe during the disposition of an uncured lining and during the curing and fusing processes. This figure shows how the process may be operated from both ends of the pipe, tube, or hollow member 1508. The pre-mix lining material is deposited on the inner surface of the pipe via the stinger with cylinder paste dispensing apparatus 1800 controlled by the process control station 1504. The process control station 1504 controls the pipe rotation, pipe longitudinal motion, the temperature, atmospheric environment, among others. The pre-mix lining material is provided by the pre-mix mixing and delivery 1200 apparatus.

Curing the pre-mix lining material deposited on the pipe may be performed with the pipe, tube, or hollow member remaining on the same fusion cart 1502. Curing is effected typically by heating the pipe, tube, or hollow member and applying air flow. Heating may be done using any heating source available, such as induction heating, flame, hot air, or other methods (not shown). The use of forced or suction ventilation (not shown) may be used to evacuate products of the curing process.

Fusion bonding of the pre-mix lining material is caused by using a lamp array mounted on a stinger 1700. The lamp array on the stinger 1700 is positioned in diametric center of the pipe. The lamp position can be obtained by many suitable ways. Additionally, support may be enhanced by use of one or more electromagnets positioned on one or more position on stinger that facilitate correct position inside pipe (not shown). An electromagnetic field provides positioning of lamp in its correct correlation to pipe.

Alternatively, a guide (not shown) may be used to provide lamp positioning in the desired location inside pipe or hollow member may be used. Generally, the guide is a tensioned wire cable inserted in pipe, tube, or hollow member from the opposite side of lamp array on the stinger until it exits on other side. Subsequently, the wire cable is attached to the lamp array side and then tensioned.

The fusion cart 1502 is constructed in manner that sets of roller engagement assemblies 1600 are separated about 400-600 mm apart and that the opposite side of the rollers is offset for about 200-400 to create a position in middle of 2 opposite side of rollers. An identical set of roller engagement assemblies 1600 are positioned from above the cart. When a pipe is rolled to position on the lower roller engagement assemblies 1600, the whole upper apparatus with roller engagement assemblies 1600 is lowered to keep pipe pressure on the pipe 1508. Any suitable mechanism may be used for this; however, hydraulic or air pressure cylinders are recommended. The rollers may be constructed from polymer, metal, rubber, and any combination.

Each roller engagement assembly 1600 can be independently moved to lose contact with pipe. Some of the roller engagement assemblies 1600 are free spinning and some are power rollers, which provide the required rotation of the pipe. Rollers are retracted from contact with pipe, tube, or hollow member in the area where the heating process is performed by the lamp. This is necessary to provide space for process control sensors and temperature control equipment (not shown). The pipe, tube or hollow member rate of rotation is determined by pipe, tube, or hollow member size, thickness, and the density of enhanced metal alloy or composite, and is controlled by the computer program and control unit 1808.

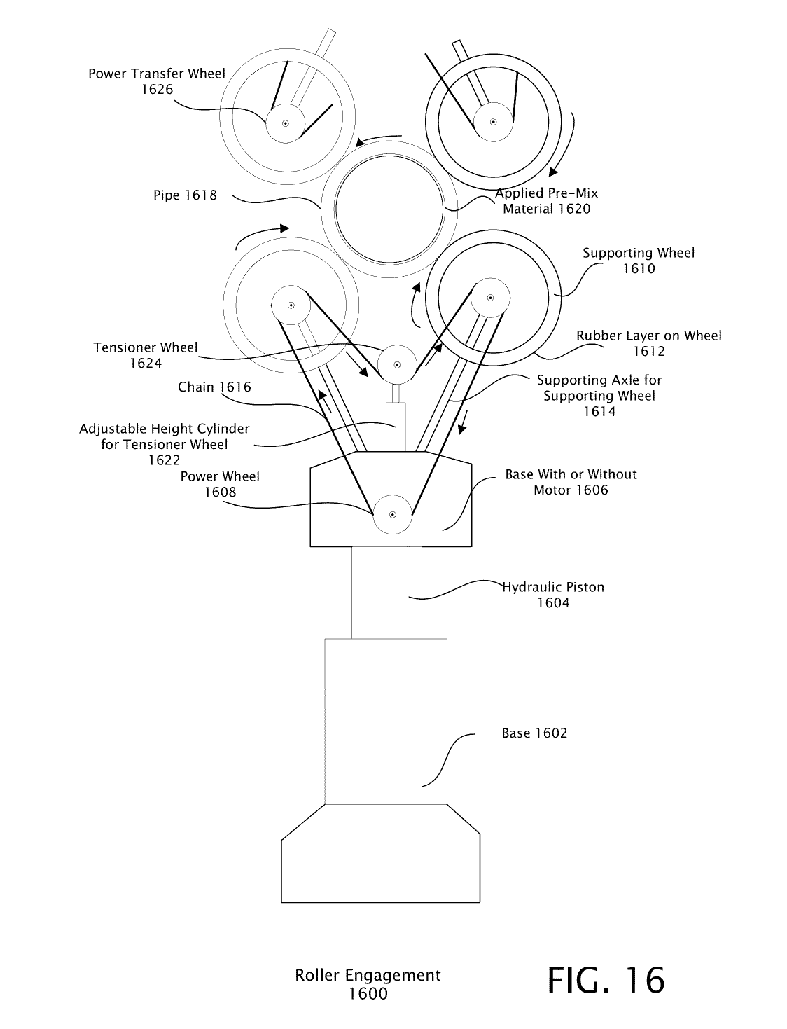

FIG. 16 shows an end view of the apparatus for rotating a pipe. The apparatus is supported by base 1602 with hydraulic piston 1604 disposed within. The hydraulic piston allows for varying the height of the base with motor 1606, depending on the size of the pipe to be processed. The base with motor 1606 drives the power wheel 1608 thereby causing the chain 1616 engaged with the power wheel 1608 to move. The moving chain 1616 causes the power transfer wheels 1623 to turn, thereby causing the supporting wheels 1610 to also rotate. It should be noted that the chain driving the power transfer wheels may be a metal chain, drive belt, cable, or any suitable material.

The supporting wheels 1610 have a rubber layer 1612 on the outer diameter to provide friction to cause the pipe 1618 with applied pre-mix lining material 1620 to rotate. Chain tension is maintained by the use of a tensioner wheel 1624 on an adjustable height cylinder 1622. A duplicate system, shown in dashed lines, is disposed 180° from the first system and offset to prevent interference, also drives the rotation of the pipe.

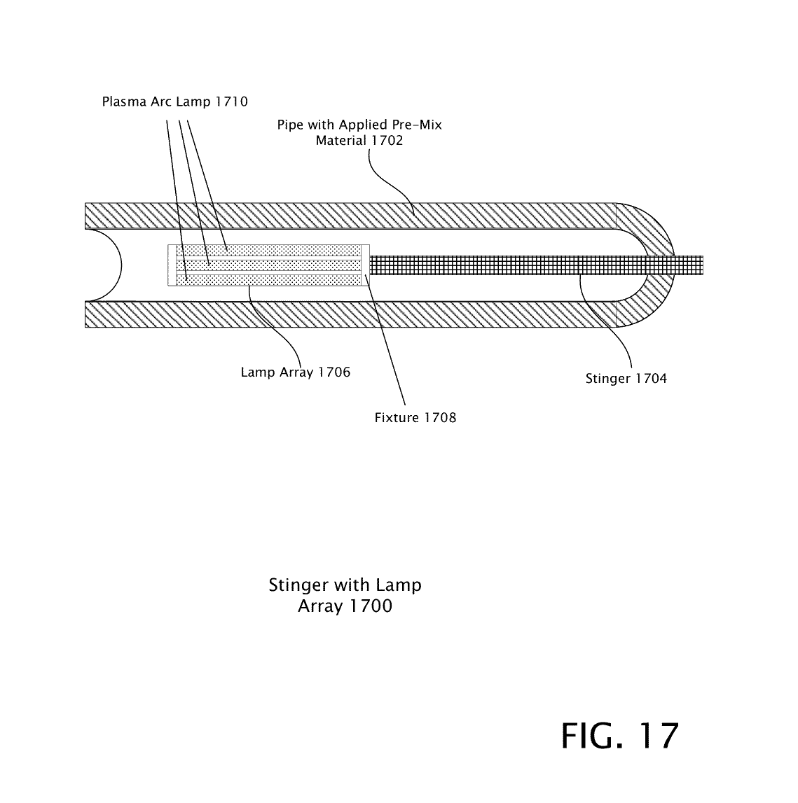

FIG. 17 shows details of a lamp assembly 1700 for curing the lining material. A lamp array 1706 may have 1 or more lamps 1708, where the number of lamps is defined by size of pipe and the thickness of deposited pre-mix material 1702. The lamps are generally arranged in circular fashion. In this figure there are six lamps, with three being visible in this view from the side, the other three lamps being present on the opposite side. Lamps of this type are generally referred to as gas sealed plasma arc lamps and can be xenon arc lamps, T3 lamps, argon arc lamps, or the like. Generally, a lamp array generates energy density between 18-350 W/cm², but any suitable energy density up to typically 900 W/cm² may be used.

The length of the lamp array can vary. Generally, a lamp 1708 about 300 mm long may be used. But lamp length can be from about 25 mm to about 600 mm.

The lamp array 1706 is mounted on the stinger 1704. The stinger can be metal, polymer, or composite. Additionally, the stinger provides support for electrical cables, cooling water, sensor cables, inert gas line, among others.

Continuing with FIG. 17, the lamp array 1706 comprises a fixture 1708 that acts as a junction point between the lamps and supply of services for operation such as electrical power, operational control, and cooling, and a plurality of plasma arc lamps mounted in the fixture.

Each plasma arc lamp 1710 in this example is a sealed gas type plasma arc lamp; however other plasma arc lamps or other comparable high intensity heat lamps of this design such as those produced by Ushio and Heraeus could also be used. Each plasma arc lamp operates by applying a sufficient electric potential across the electrodes to ionize the pressurized gas inside the lamp, thereby generating electromagnetic radiation primarily in the infrared, visible and UV spectrums, which radiate out of the plasma arc lamp and generate heat upon contact with the pipe or tubular surface.

The radiation emitted by each plasma arc lamp 1710 in the array overlaps with each other and collectively heat the entire circumference of the interior surface of the pipe or tubular. Heating is substantially achieved in 360 degrees about the lamp Array 1706 long axis and fuses the premix-material to the pipe 1702, forming a lined pipe.

The illustrated example in FIG. 17 features six arc lamps which are evenly spaced forming a circular lamp array, however the lamp array can comprise a different number of arc lamps depending on factors such as the diameter of the pipe to be treated, desired thermal output, etc.

In order to keep the lamps within a safe operational temperature during the fusion or metallurgical bonding process, each arc lamp may be fitted with an individual cooling assembly where coolant is circulated through a functional clear outer tube. The outer tube is positioned and connected to the array fixture. Typically the lamps are equipped with a clear silica glass jacket, as this material allows a coolant to remove heat from the lamp, while not substantially impeding the light emitted from the lamp.

Also illustrated is a stinger 1704 or support arm mechanism that facilitates the axial travel of the lamp array along the interior length of the pipe or tube, the stinger also acting as the utility support and conduit for the electrical power, operational control, and cooling supply needed to facilitate, control, and monitor operation.

Such a suitable lamp array 1706 is further described in pending U.S. Patent Application Ser. No. 61/828,102, filed May 28, 2013, entitled “Apparatus for Thermal Treatment of an Inner Surface of a Tubular or Other Enclosed Structure”, by Bumbulovic, the contents of which are incorporated by reference herein.

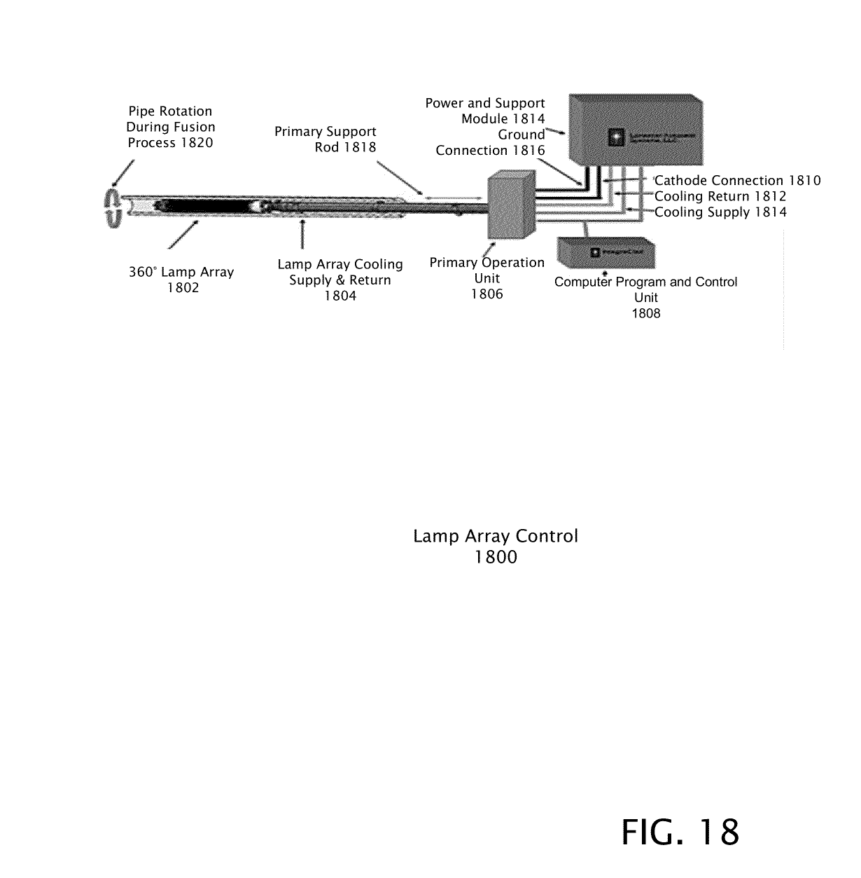

FIG. 18 shows a system for controlling the lamp assembly. Here, a pipe with a cured pre-mix lining material on its inner surface 1822 has a stinger 1818 with a lamp array on its distal end inserted into the diametric center of the pipe 1822. The pipe with cured pre-mix lining material 1822 is typically mounted in a processing system (not shown) as illuminated in FIG. 15, which provides for pipe rotation 1820 during processing.

Distributed along the stinger 1818 is the lamp array cooling supply and return 1804. The cooling supply and return 1804 provides water from the power and support module 1814 for cooling the lamp array during its operation, and return of the heated water to the power and support module 1814. Cooling the lamp array 1802 extends the useful lifetime.

The computer program and control unit 1808 provides instruction to the power and support module 1814 and the primary operation unit 1806. Such instructions as transit time, lamp intensity, cooling rate, and others as required, are provided for specific processing of particular pipes and pre-mix lining material compositions and thicknesses.

Those skilled in the art will realize that the process sequences described above may be equivalently performed in any order to achieve a desired result. Also, sub-processes may typically be omitted as desired without taking away from the overall functionality of the processes described above.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method for metallurgically bonding a layer of performance enhancing metal alloy to the internal surface of a steel pipe or tubular structure comprising:
applying a metal alloy in the form of a paste to an internal surface of the pipe or steel tubular structure, while the steel tubular structure is rotated on its long axis, to substantially uniformly spread the paste through centrifugal force acting on the paste layer; and
exposing a paste layer to heat generated by a plurality sealed gas plasma arc lamps uniformly radiating heat in substantially 360 degrees about the long axis of the pipe or steel tubular structure, to form a layer of performance enhancing metal alloy on the internal surface of the pipe or steel tubular structure, where the energy radiated from the plurality of xenon electrode lamps or similar electrode lamps is substantially from 35 watts per square centimeter to 900 watts per square centimeter, whereby the uniformity of the metal alloy lining produced during the metallurgical bonding process is enhanced with centrifugal force or pressure.

2. The method for metallurgically bonding a layer of performance enhancing metal alloy to the internal surface of a steel tubular structure of claim 1 in which the paste includes the metal alloy in finely divided powder form, mixed into a semi-liquid to semi-solid paste with a binder.

3. The method for metallurgically bonding a layer of performance enhancing metal alloy to the internal surface of a pipe or steel tubular structure of claim 2 in which the binder is a finely divided non-contaminating powder when mixed with a wetting agent such as water becomes gelatinous.

4. The method for metallurgically bonding a layer of performance enhancing metal alloy to the internal surface of a steel tubular structure of claim 1, where the rotation to create centrifugal force or pressure is between 200 rpm to 1600 rpm.

4. The method for metallurgically bonding a layer of performance enhancing metal alloy to the internal surface of a pipe or steel tubular structure of claim 2 in which the binder is a low carbon forming solid, liquid, or semi-liquid binder material.

5. The method for metallurgically bonding a layer of performance enhancing metal alloy to the internal surface of a steel tubular structure of claim 2 in which the metal alloy may be primarily comprised of chromium alloy, tin alloy, nickel alloy, cobalt alloy, copper alloy, aluminum alloy, zinc alloy, titanium alloy, stainless steel and other iron based alloys, or semi-amorphous alloys.

6. The method for metallurgically bonding a layer of performance enhancing metal alloy to the internal surface of a steel tubular structure of claim 2 where the metal alloy is mixed with an additive selected from the group consisting of performance enhancing non-metal materials and functional fillers like carbides, nitrides, borides, silicide, and oxides.

7. The method for metallurgically bonding a layer of performance enhancing metal alloy to the internal surface of a steel tubular structure of claim 1 in which the paste is applied onto the interior surface of the steel tubular structure in a uniform layer.

8. The method for metallurgically bonding a layer of performance enhancing metal alloy to the internal surface of a steel tubular structure of claim 2 in which the binder has thixotropic and adhesive properties to facilitate and maintain uniform placement of a mixed metal alloy.

9. The method for metallurgically bonding a layer of performance enhancing metal alloy to the internal surface of a steel tubular structure of claim 2, in which the mixed metal alloy is deposited onto the pipe or tubular structure at a uniform thickness of 100 microns to 4 millimeters per application.

10. The method for metallurgically bonding a layer of performance enhancing metal alloy to the internal surface of a steel tubular structure of claim 1, in which the plurality of sealed gas plasma arc lamps are fixed to a support mechanism forming an array that allows axial travel along the interior length of the steel pipe or tubular structure.

11. The method for metallurgically bonding a layer of performance enhancing metal alloy to the internal surface of a pipe or steel tubular structure of claim 10 is comprised of a plurality of sealed gas filled plasma arc lamps or similar source of electromagnetic radiation.

12. The method of claim 1 where based on the chemical composition of the metal alloy and base metal surface, an atmosphere of inert gas or combination of inert gasses such as argon, argon-hydrogen mix, or carbon dioxide may be introduced into the interior atmosphere at the proximity of the lamp and maintained during the metallurgical bonding and cooling process.

13. A method of lining a steel pipe comprising:
controlling the lining the steel pipe using inline time and temperature control of the pipe; and
post process heat treating the lined steel pipe.

14. The method of claim 13 where the mechanical and/or metallurgical properties of the steel pipe or tubular structure are controlled or created by the use of inline time-temperature cooling or quenching and/or post processing heat treatment.

15. The method of lining a steel pipe of claim 13 further comprising cooling the lined steel pipe at a controlled rate from the exterior, the interior, or both the exterior and interior after metallurgically bonding a metal alloy to an interior surface of the steel pipe.

16. The method of lining a steel pipe of claim 15 in which temperature control further comprises:
cooling the steel pipe by application of water on the outside of the pipe; and
flooding the interior of the pipe with an inert shielding gas.

17. The method of lining a steel pipe of claim 16 in which cooling and flooding are performed simultaneously.

18. The method of lining a steel pipe of claim 16 in which the shielding gas is argon.

19. The method of lining a steel pipe of claim 16 in which the shielding gas is a mixture shielding gases such as argon and hydrogen or argon and carbon dioxide.

20. The method of lining a steel pipe of claim 16 in which post process heat treating is performed to produce desired mechanical and or metallurgical properties by use of a furnace to heat the entire pipe, followed by controlled cooling.
